(19) United States
(12) Patent Application Publication
(10) Pub. No.: US 2024/0182245 A1
(43) Pub. Date: Jun. 6, 2024

(54) SORTING DEVICE

(71) Applicant: MARTISTEL INNOVATION FZCO, Dubai (AE)

(72) Inventors: Sergey RAZUMOV, Strovolos (CY); Oleg SULTANOV, Moscow (RU)

(21) Appl. No.: 18/285,265

(22) PCT Filed: Apr. 1, 2022
(86) PCT No.: PCT/EP2022/058762

§ 371 Date: Oct. 2, 2023

(30) Foreign Application Priority Data
Apr. 1, 2021 (EP) 21166762.1

(51) Int. Cl. B65G 1/06; B65G 1/04

(52) U.S. Cl. CPC B65G 1/065; B65G 1/0471

(57) ABSTRACT

System for storing and organizing materials, comprising:

a storage system, at least a first layer comprising a plurality of storage locations, which are preferably arranged in rows in two horizontal directions perpendicular to one another and serve to receive boxes in stacks, at least one transport device which has a receiving area for individual boxes or stacks of boxes for or from the storage system, a transport system, in particular a rail arrangement, on which the at least one transport device is mounted so that it can be moved to and within the storage system and can be delivered for individual stacking of boxes, and a re-sorting device with at least one gripper, which is connected to the storage system via the transport system and is designed to pick up a subset of boxes or all boxes of a stack of boxes from the transport device, lift them and return them to the transport device or another transport device.

The present invention relates to a re-sorting device according to claim 1.

For a better understanding of the essence of the proposed technical solution, below follows the description of a specific implementation example, which is not a limiting example of the practical implementation of an automatic system for storing materials and collecting sets thereof.

The claimed invention is explained in more detail with reference to the accompanying drawings. Show it:

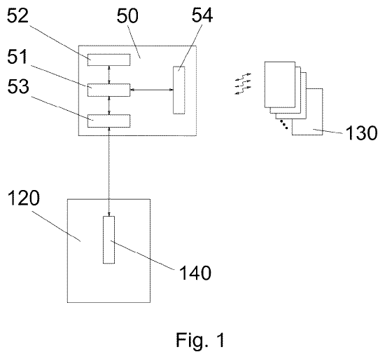

FIG. 1 is a general diagram of an automatic system,

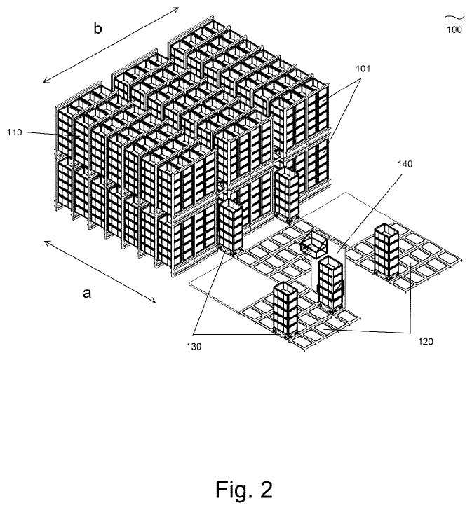

FIG. 2 an automatic system, front view, perspective view,

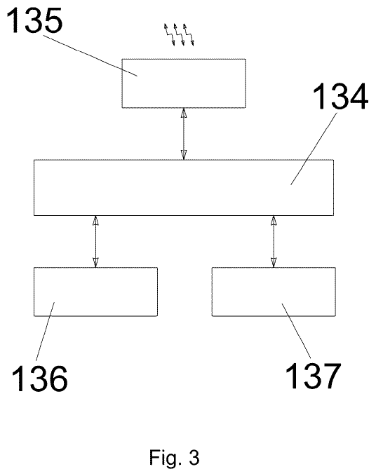

FIG. 3 is a schematic diagram of a mobile transport device,

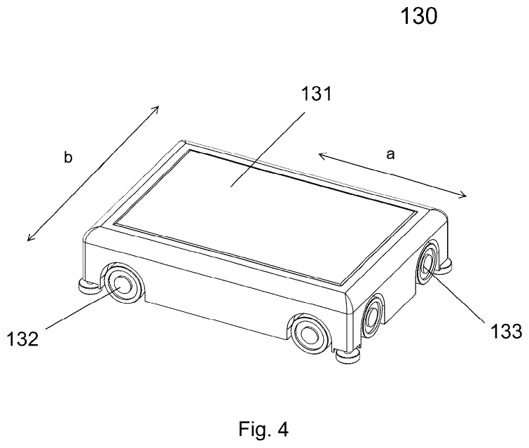

FIG. 4 shows a general view of a mobile transport device,

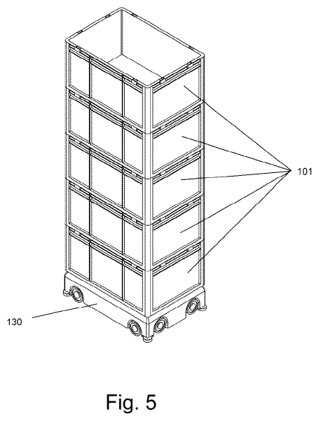

FIG. 5 shows a mobile transport device with a stack of bowls on board,

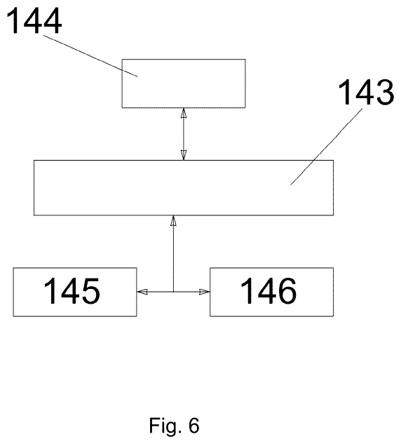

FIG. 6 is a schematic diagram of a device for lifting stacks of trays,

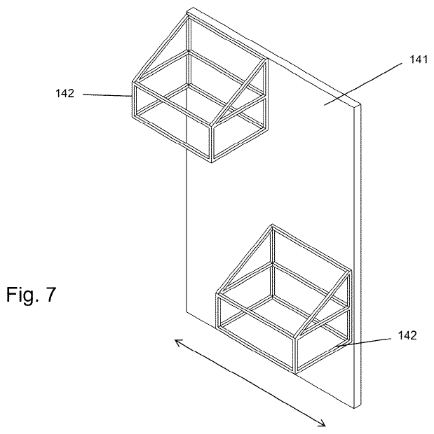

FIG. 7 shows a device for lifting stacks of trays, general view,

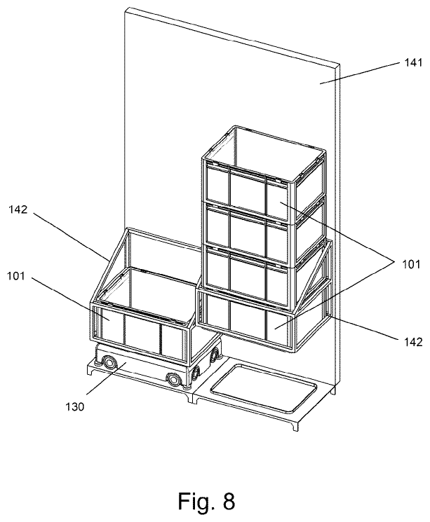

FIG. 8 shows a device for lifting stacks of trays interacting with stacks of trays and a mobile transport device,

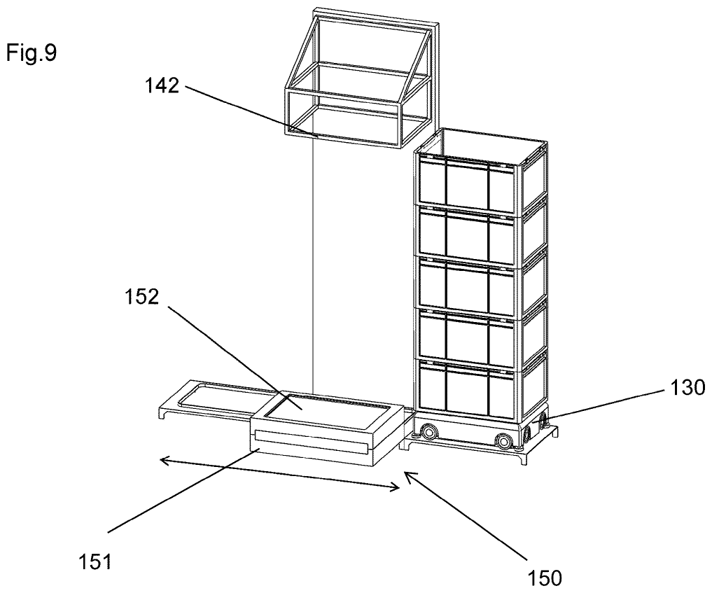

FIGS. 9-11 an alternative embodiment with a gripper and a movable storage area/storage device, which can replace the second gripper with an advantageous movement sequence and

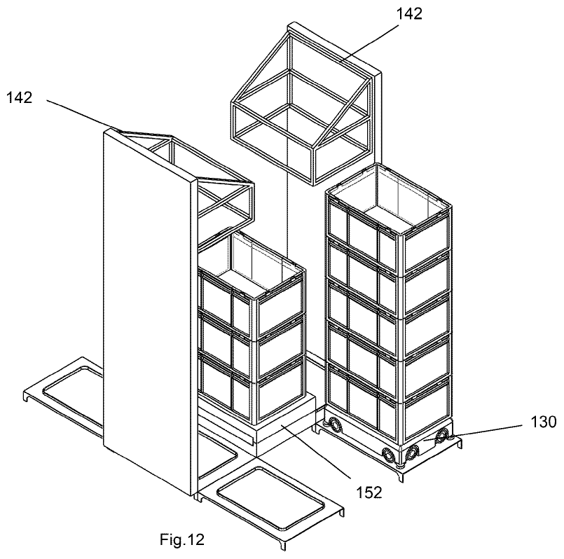

FIG. 12 shows a combination of the first and second embodiments, i.e. with at least one further gripper and at least one movable storage area/storage device.

As shown in FIGS. 1 and 2, the automatic box storage system and/or the organization system preferably includes a control module 50 and/or a storage system 110 and/or a box/tray sorting area 120. The control module 50 has a central control processor 51 and/or an order processing unit 52 and/or an interface 53 and/or a wireless interface 54, preferably to the device 120 and/or 140.

Multiple mobile transport devices 130 can be controlled by a central processor 50 via a wireless interface 54 and/or are provided, both empty and full boxes/trays as well as stacked boxes/trays 101 (FIG. 5) both within the storage system 110 and (and/or) in the sorting area of the trays 120 and between the mentioned areas.

As in FIG. 2, at least one, preferably at least two devices for lifting 140/142 stacks of boxes/trays 130 are present in the box/tray sorting area 120. In particular, the device 140/142 can be designed to lift boxes/trays from a transport device, preferably in the sorting area. All boxes/trays as well as a subset of boxes/trays can be lifted or picked up by the transport device. Additionally, the box/tray sorting area 120 may contain multiple buffer locations to accommodate multiple MTUs 130 or their boxes if they ar-rive early and are awaiting further processing.

The trays within the storage system 110 are stored in stacks of preferably n trays one above the other, in a special casen>=5, as shown in the figures.

As in FIG. 2, the storage area of stacked trays 110 can be designed on several levels with several separate stacks 110 one above the other.

The transport device 130 shown in FIGS. 3-5 preferably comprises a lifting table 131, which is designed for receiving and transporting trays/boxes 101 or stacking trays/boxes thereof, and two groups of drive wheels 132 and 133, which divide the device into two should move in mutually perpendicular horizontal directions.

The structural design of the MTU 130 or the storage device 110 is manufactured in such a way that an empty device 130 with its lifting table 131 without any trays/boxes located/transported on it can be moved freely in the storage area 110 underneath the stacks. This means that the MTU can also be delivered to stacks that are located further back in the storage area, without having to take a detour around the storage area itself.

The mobile transport device/unit 130, which is preferably part of the storage and sorting system according to the invention, can be controlled in any known manner. In particular, an embedded (industrial) controller 134 with a wireless interface 135 for communicating with the central processor 51 of the automatic system can be used for control. The controller 134 controls the drivers 136 of the drives of the wheels 132 and 133 for movement, preferably along rails, in preferably two directions in a plane and/or the driver 137 of the vertical position of the wheels 132, 133, above which the wheels are raised and as a result the underside of the lifting table can touch the floor and/or the state of the lifting table 131 (height adjustability). The rails can be present in the storage area 110 and/or in the sorting area, i.e. also between the areas, and can be provided as a basis for the movement of the transport devices 130. FIGS. 6 to 8 shows a device 140 for lifting individual or stacks of boxes/trays with a (base) body 141 and at least two grippers 142 which move in a vertical direction relative to the body 141 and do the gripping/Enable picking up and lifting of any number of boxes/pan 101 from or onto a MTU 130 in the operating range of the grippers 142. The MTU for picking up/grasping the boxes/trays by a gripper is preferably located below the gripper. The gripper can be provided with a frame which is dimensioned so that it can be placed over a stack of boxes. The grippers can be equipped with holding ele-ments/retaining lugs/retaining brackets or other devices which can be delivered to the pans/boxes, which are designed to hold boxes/pan 101 which are placed on the gripper (put over them, see e.g. FIG. 8). 142 to hold.

The device for lifting stacks of trays 140 may also be controlled in any known manner. In particular, an embedded industrial controller 143 may be used, which has an interface 144 for communicating with the central processor 51 of the automatic system 100. The controller 143 preferably controls the drivers 145 and 146 of the respective gripper drives 142 for picking up and lifting the (stack of) tray(s)/box(es) 101 in the vertical 105 direction.

FIG. 8 shows the interaction of the device 140 for lifting stacks of trays with trays/boxes 101 standing on the mobile transport device 130. As can be seen, the mobile transport device 130 first approaches the first (right) gripper 142 of the device 140, the first gripper 142 being selected in the present example, the four upper boxes/trays 101 of the 110 stack standing on the MTU 130, to raise.

Thereafter, the MTU 130 moves in a first horizontal direction under the second (left) gripper 142 of the device 140. Then the second gripper 142 lifts the (remaining) tray/box 101 from the MTU 130.

The MTU then moves beneath the first gripper 142 of the device 140, whereby the first lifted stack of trays/boxes 101 is placed on the MTU 130. The MTU 130 then moves again beneath the second (correspondingly raised) gripper 142 of the device 140, which now places the previously lower tray/box 101 of the stack on top of the stack.

According to the present invention, the “systems” described and claimed may be devices and devices.

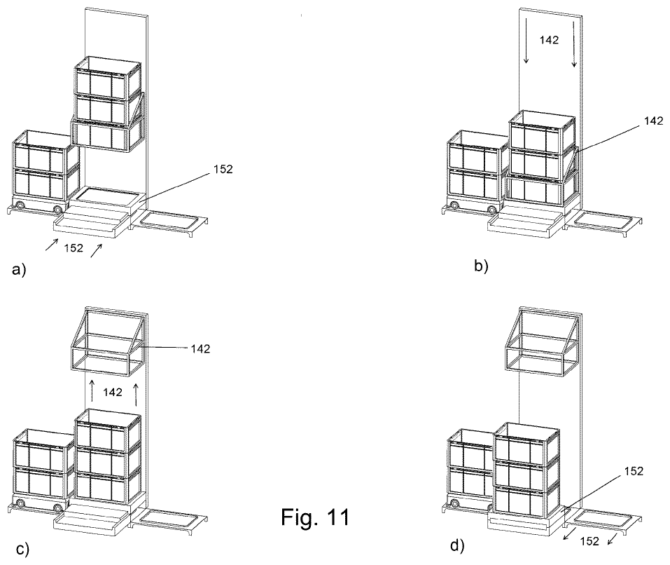

Alternatively or additionally, it can be provided, instead of a second gripper, to provide a movable storage area/storage device in the vicinity of the gripper (FIGS. 9-11). A movable part 152 of the storage area/storage device 150, for example a movable shelf or a (slidable/displaceable) conveyor belt, can be deliverable to the gripper 142, whereby the gripper can transfer picked-up boxes to the storage area/storage device (e.g. B. place it on this—see FIG. 11b).

The storage device can have a stationary base 151, on and/or relative to which the movable part 152 of the storage device is displaceably mounted.

The movable storage area/storage device can then be moved away from the gripper (below the gripper) (FIG. 11c, →11d), whereby a loading area (below) the gripper, i.e. an area, is released (FIG. 11d) in which a mobile transport device 130 can be provided so that the gripper can take over its boxes or deliver them to them,

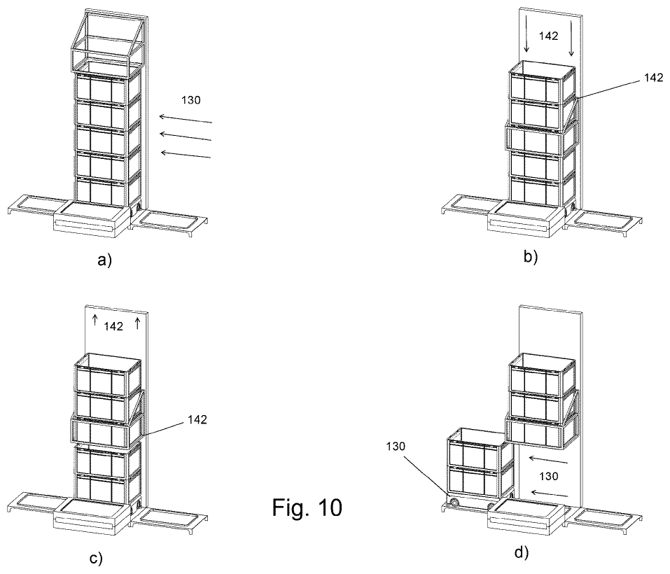

This makes it possible for the gripper, for example, to first take over one or more boxes from a transport device (FIG. 10b, →11c), then hand them over to the storage area/storage device (FIG. 11a, →11b, →11c) and thereby be released for receiving further boxes. If there is an empty transport device next to the movable storage area/storage device and/or in the loading area of the gripper, the movable storage area/deposit device can transfer the temporarily stored boxes (subset) to the transport device again. Alternatively, the storage area/storage device can hand the boxes back to the gripper 142 at an appropriate time, which makes it possible to re-sort the boxes of one or more transport devices.

According to the present invention, re-sorting can in particular mean being able to change the order of boxes in an existing stack of boxes using the device according to the invention.

According to the present invention, a stack of boxes is preferably a set of at least two, preferably three, four, five or more boxes arranged one above/on top of the other.

According to the present invention, a subset of boxes of a stack can be at least one box less than is present in the respective stack.

The transport device can then be removed with the subset of boxes for further processing, or the additional boxes picked up by the gripper can be loaded onto the subset. This makes it possible to sort boxes/a stack on a transport device using either at least two grippers or at least one gripper in combination with the mobile storage area/storage device described above. The present invention relates to a corresponding device and a corresponding method.

In principle, it is also conceivable to provide a combination of the first and second embodiments, as can be seen by way of example in FIG. 12. This allows boxes to be exchanged as in the embodiment of FIGS. 9-11, but also boxes to be exchanged between different transport devices 130 or boxes to be transferred from one transport device to a second.

A possible re-sorting using the embodiment according to FIG. 11 could take place, for example, as follows:

A first transport device 130 is moved into an area below a first of the two grippers 142 shown. This first gripper 142 takes any number of boxes from the transport device 130. The first gripper 142 then transfers the boxes or a subset of boxes to the movable part 152 of the storage area/storage device, which can be delivered to this first gripper.

On the other hand, with the second gripper 142, it can now either take over the boxes from the storage area/storage device, which is delivered to the second gripper 142, or the gripper is already loaded with boxes, which the gripper puts on the stack of boxes in the storage area/storage device, as long as the storage area/deposit device is delivered to the gripper. The gripper can then in turn lift all of the boxes or a subset of the merged boxes and, after the storage area/storage device has been withdrawn from the loading area of the second gripper (along with the remaining boxes, if applicable), the held boxes of the second gripper onto one Transfer device 130, which is positioned in the loading area of the second gripper s 142.

This makes it possible to shift between different transport devices 130 and/or change the order of boxes in a transport device 130.

1. System for storing and organizing materials, comprising:
a storage area (110),
at least one first layer (100), preferably a plurality of layers, comprising a plurality of storage locations, which are preferably arranged in rows in two horizontal directions perpendicular to one another and serve to accommodate boxes as a storage location for the materials in stacks,
at least one transport device (130) which has a receiving area for individual boxes or stacks of boxes to or from the storage system,
a transport system, in particular a rail arrangement, on which the at least one transport device (130) is mounted so that it can be moved from, to and within the storage system (s) and can be delivered to individual stacks of boxes in the storage system (110) and
a re-sorting device (140) with
at least one first gripper (142), which is connected to the storage system via the transport system and is designed to pick up one, preferably at least two, particularly preferably any number/subset of boxes from the stack of boxes, lift them and return them again to the transport device or to a different transport device (130),
at least one second gripper (142), to which the transport device (130) can be delivered in a loading area of the second gripper and is designed to pick up at least a subset of the remaining boxes of the stack from the transport device (130), and
a movable storage device (150), which can be delivered to the first and/or the second gripper or a loading area of the gripper(s), and is designed to take picked up boxes from the gripper (s) and from the loading area to move the gripper(s) in a separate storage device of the sorting device for tempo-rary storage, whereby the loading area of the gripper(s) is freed up for picking up or delivering boxes to/from a transport device, wherein the picked up boxes can be temporarily stored in the storage device, preferably next to at least one of the grippers.

2. System for storing and organizing materials according to claim 1,
Wherein the gripper is height-adjustable and is designed to lift boxes from the transport device (130).

3. System for storing and organizing materials according to claim 1,
wherein the movable storage device (150) has a displaceable storage surface (152) or a conveyor belt which can be delivered to the loading area of the gripper.

4. System for storing and organizing materials according to claim 1,
wherein the transport system is arranged in areas below the gripper (142) and forms the loading area for the gripper or grippers (142).

5. System for storing and organizing materials according to claim 1,
wherein the movable storage device (150) can be delivered to the respective loading area of a plurality of grippers (142).

6. Re-sorting device for a system according to claim 1 with
at least a first gripper (142), which is connected to the storage system via a transport system and is designed to pick up a subset of boxes arranged on the transport device (130) or all to hold these boxes from a transport device (130) which is placed in a loading area of the gripper, and then hand them back to the transport device (130) or to another transport device (130),
at least a second gripper (142) and a loading area for the gripper to which the transport device (130) can be delivered, the second gripper (142) being configured to receive a subset of the remaining boxes or all of the transport device (130) arranged in the loading area remaining boxes
and
a storage device (150), preferably with a fixed base (151), and a movable storage device, which is displaceable between a storage position and a loading position in the loading area of at least the first gripper (142), and configured to pick up boxes held by the gripper (142) preferably by any gripper, and store them outside the loading area, but preferably adjacent to it, whereby access to the loading area of the gripper (142) is freed up for op-tionally further boxes and/or a transport device (130).

7. Re-sorting device according to claim 6,
wherein both a second gripper (142) and a storage device (150) are provided, the storage device (150) being arranged between the storage areas of the two grippers, the movable storage surface (152) of the storage device (150) can be delivered towards the respective loading area of both grippers (142) and the Grippers are designed to pick up boxes provided on the movable storage area to the respective gripper or to take hand over to the movable storage area.

8. Method for organizing materials using the system according to claim 1, in which the materials are stored in boxes (101) and the boxes (101) are orga-nized in stacks,
wherein the stacks of boxes can be transported by means of at least one transport device (130) between a storage system (110) for the stacks and a re-sorting device (140) for the boxes (101) of a stack,
wherein at least some of the transported boxes (101) of one stack of boxes (101) are taken over in a loading area of the re-sorting device (140),
wherein the re-sorting device has at least one first gripper (142) which picks up and holds the subset of the boxes (101) to be taken from the stack of boxes and are lifted by means of the at least one first gripper (142), so that the transport device (130) can be moved out of the loading area of the gripper (142) without the taken subset of the boxes (101),
where
either at least a second gripper (142) is provided, which lifts a further part or all of the further boxes from the transport system and thus further reduces the number of boxes on the transport system and then the transport device is delivered to the first gripper, which is supplied by the first gripper transferred the held boxes to the transport system,
or
a movable storage device (150) is arranged adjacent to the loading area of the at least one first gripper, which receives and temporarily stores boxes from the transport device or the at least one first gripper (142), whereby the transport device or the at least one first gripper (142) is freed up for receiving boxes from the other part, i.e. the gripper or the transport device, and the intermediately stored boxes are transferred to an empty transport device or to the at least one first gripper for re-sorting the order of boxes on the transport device (130), become.
